(19) United States
(12) Patent Application Publication
(10) Pub. No.: US 2026/0217213 A1
(43) Pub. Date: Jul. 30, 2026

(54) VEHICLE OCCUPANT RESTRAINT DEVICE AND VEHICLE

(71) Applicant: TOYOTA JIDOSHA KABUSHIKI KAISHA, Toyota-shi (JP)

(72) Inventor: Mitsuyoshi OHNO, Miyoshi-shi (JP)

(73) Assignee: TOYOTA JIDOSHA KABUSHIKI KAISHA, Toyota-shi (JP)

(21) Appl. No.: 19/390,622

(22) Filed: Nov. 16, 2025

(30) Foreign Application Priority Data
Jan. 24, 2025 (JP) 2025-010457

(51) Int. Cl. B60R 22/02; B60R 22/48; B60N 2/14

(52) U.S. Cl. CPC B60R 22/023; B60R 22/48; B60N 2/143; B60R 2022/4816; B60R 2022/4866

(57) ABSTRACT

Provided are a vehicle occupant restraint device including: a rotating seat changeable between a forward-facing posture and a rearward-facing posture; a first buckle and a second buckle that are provided on both left and right sides of the rotating seat, respectively; a first seat belt device that is provided on a B pillar side and includes a first tongue attachable to and detachable from the first buckle that is located on an inner side in a vehicle-width direction in a case where the rotating seat is in the forward-facing posture; and a second seat belt device that is provided on an instrument panel side and includes a second tongue attachable to and detachable from the second buckle that is located on the inner side in the vehicle-width direction in a case where the rotating seat is in the rearward-facing posture, and a vehicle including the vehicle occupant restraint device.

### CROSS-REFERENCE TO RELATED APPLICATION

This application claims priority to Japanese Patent Application No. 2025-010457 filed on January 24, 2025. The disclosure of the above-identified application, including the specification, drawings, and claims, is incorporated by reference herein in its entirety.

### BACKGROUND

### 1. Technical Field

The present disclosure relates to a vehicle occupant restraint device and a vehicle.

### 2. Description of Related Art

A vehicle in which a front seat is a rotating seat that is changeable between a forward-facing posture and a rearward-facing posture, and a three-point seat belt that restrains a seated occupant is mounted on the rotating seat has been known in the related art (see, for example, Japanese Unexamined Patent Application Publication No. 2024-056515 (JP 2024-056515 A)).

### SUMMARY

However, in such a configuration, rigidity of the rotating seat needs to be increased to withstand a load of a shoulder belt located at the chest of the occupant in the seat belt, thereby significantly increasing mass of the rotating seat. In addition, since a buckle of the rotating seat is set on an inner side in a vehicle-width direction while the rotating seat is in the forward-facing posture, in a case where the rotating seat is rotated to be in the rearward-facing posture, the buckle is located on an outer side in the vehicle-width direction. Therefore, in a case where a side door intrudes on the inner side in the vehicle-width direction at the time of a side collision of the vehicle, a tongue is difficult to be released from the buckle.

Therefore, the present disclosure provides a vehicle occupant restraint device that can inhibit an increase in mass of a rotating seat and allows a tongue to be easily released from a buckle even at the time of a side collision of a vehicle in a state where the rotating seat is in a rearward-facing posture, and a vehicle including the vehicle occupant restraint device.

A vehicle occupant restraint device according to a first aspect of the present disclosure includes a rotating seat provided as a front seat of a vehicle and changeable between a forward-facing posture and a rearward-facing posture, a first buckle and a second buckle that are provided on both left and right sides of the rotating seat, respectively, a first seat belt device provided on a B pillar side and including a first tongue attachable to and detachable from the first buckle that is located on an inner side in a vehicle-width direction when the rotating seat is in the forward-facing posture, and a second seat belt device provided on an instrument panel side and including a second tongue attachable to and detachable from the second buckle that is located on the inner side in the vehicle-width direction when the rotating seat is in the rearward-facing posture.

According to the first aspect, the rotating seat that is changeable between the forward-facing posture and the rearward-facing posture is provided as the front seat of the vehicle, and the first buckle and the second buckle are provided on both the left and right sides of the rotating seat, respectively. The first seat belt device that includes the first tongue attachable to and detachable from the first buckle that is located on the inner side in the vehicle-width direction when the rotating seat is in the forward-facing posture is provided on the B pillar side. The second seat belt device that includes the second tongue attachable to and detachable from the second buckle that is located on the inner side in the vehicle-width direction when the rotating seat is in the rearward-facing posture is provided on the instrument panel side.

Therefore, in a case where the rotating seat is in the forward-facing posture, a load of a shoulder belt in a seat belt is received by the B pillar. In addition, in a case where the rotating seat is in the rearward-facing posture, the load of the shoulder belt in the seat belt is received by the instrument panel. Accordingly, rigidity of the rotating seat need not be increased, thereby inhibiting the increase in mass of the rotating seat. In addition, since a buckle to be used is always a buckle located on the inner side in the vehicle-width direction, the second tongue is easily released from the second buckle even at the time of the side collision of the vehicle in a state where the rotating seat is in the rearward-facing posture.

In addition, a vehicle occupant restraint device according to a second aspect of the present disclosure includes a rotating seat provided as a rear seat of a vehicle and changeable between a forward-facing posture and a rearward-facing posture, a first buckle and a second buckle that are provided on both left and right sides of the rotating seat, respectively, a first seat belt device provided on a C pillar side and including a first tongue attachable to and detachable from the first buckle that is located on an inner side in a vehicle-width direction when the rotating seat is in the forward-facing posture, and a second seat belt device provided on a B pillar side and including a second tongue attachable to and detachable from the second buckle that is located on the inner side in the vehicle-width direction when the rotating seat is in the rearward-facing posture.

According to the second aspect, the rotating seat that is changeable between the forward-facing posture and the rearward-facing posture is provided as the rear seat of the vehicle. The first buckle and the second buckle are provided on both the left and right sides of the rotating seat, respectively. The first seat belt device that includes the first tongue attachable to and detachable from the first buckle that is located on the inner side in the vehicle-width direction when the rotating seat is in the forward-facing posture is provided on the C pillar side. The second seat belt device that includes the second tongue attachable to and detachable from the second buckle that is located on the inner side in the vehicle-width direction when the rotating seat is in the rearward-facing posture is provided on the B pillar side.

Therefore, in a case where the rotating seat is in the forward-facing posture, the load of the shoulder belt in the seat belt is received by the C pillar, and in a case where the rotating seat is in the rearward-facing posture, the load of the shoulder belt in the seat belt is received by the B pillar. Accordingly, rigidity of the rotating seat need not be increased, thereby inhibiting the increase in mass of the rotating seat. In addition, since a buckle to be used is always a buckle located on the inner side in the vehicle-width direction, the second tongue is easily released from the second buckle even at the time of the side collision of the vehicle in a state where the rotating seat is in the rearward-facing posture.

In addition, in the first and second aspects, a vehicle may include the vehicle occupant restraint device according to the first or second aspect, a discrimination device provided on the rotating seat or a floor and configured to discriminate an orientation of the rotating seat, an attachment and detachment detection device provided on each of the first buckle and the second buckle and configured to detect that the first tongue or the second tongue is attached, a warning sound generation device configured to generate a warning sound for an occupant, and a control device electrically connected to the discrimination device, the attachment and detachment detection device, and the warning sound generation device. The control device may be configured to control the warning sound generation device to generate the warning sound when a determination is made that a detection result of the attachment and detachment detection device is incompatible with the orientation of the rotating seat discriminated by the discrimination device and a vehicle speed is equal to or higher than a predetermined speed.

With the above-described configuration, the discrimination device that discriminates the orientation of the rotating seat is provided on the rotating seat or the floor. The attachment and detachment detection device that detects that the first tongue or the second tongue is attached is provided on each of the first buckle and the second buckle. The vehicle includes the warning sound generation device that generates the warning sound for the occupant, and the control device that is electrically connected to the discrimination device, the attachment and detachment detection device, and the warning sound generation device.

Here, in a case where a determination is made that the detection result of the attachment and detachment detection device is incompatible with the orientation of the rotating seat discriminated by the discrimination device and the vehicle speed is equal to or higher than the predetermined speed, the control device controls the warning sound generation device to generate the warning sound. Therefore, it is possible to prompt the occupant who is sitting on the rotating seat to correctly wear the seat belt.

As described above, according to the present disclosure, it is possible to inhibit the increase in mass of the rotating seat, and it is possible to easily release the tongue from the buckle even at the time of the side collision of the vehicle in a state where the rotating seat is in the rearward-facing posture.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view showing a state when a rotating seat of a vehicle occupant restraint device according to a first embodiment is in a forward-facing posture;

FIG. 2 is a schematic plan view showing a state when the rotating seat of the vehicle occupant restraint device according to the first embodiment is in the forward-facing posture;

FIG. 3 is a schematic side view showing a state when the rotating seat of the vehicle occupant restraint device according to the first embodiment is in a rearward-facing posture;

FIG. 4 is a schematic plan view showing a state when the rotating seat of the vehicle occupant restraint device according to the first embodiment is in the rearward-facing posture;

FIG. 5 is a schematic plan view showing a state when a rotating seat of a vehicle occupant restraint device according to a second embodiment is in the forward-facing posture; and

FIG. 6 is a schematic plan view showing a state when the rotating seat of the vehicle occupant restraint device according to the second embodiment is in the rearward-facing posture.

### DETAILED DESCRIPTION OF EMBODIMENTS

Hereinafter, embodiments according to the present disclosure will be described in detail with reference to the drawings. For convenience of description, an arrow UP shown in each drawing as appropriate is referred to as a vehicle upward direction, an arrow FR is referred to as a vehicle front direction, and an arrow RH is referred to as a vehicle right direction. In addition, in the following description, unless otherwise specified, directions of up and down, front and rear, and left and right are described, the directions refer, respectively, to the up and down, front and rear, and left and right of the vehicle. In addition, the left-right direction is the same as a vehicle-width direction and a seat width direction.

### First Embodiment

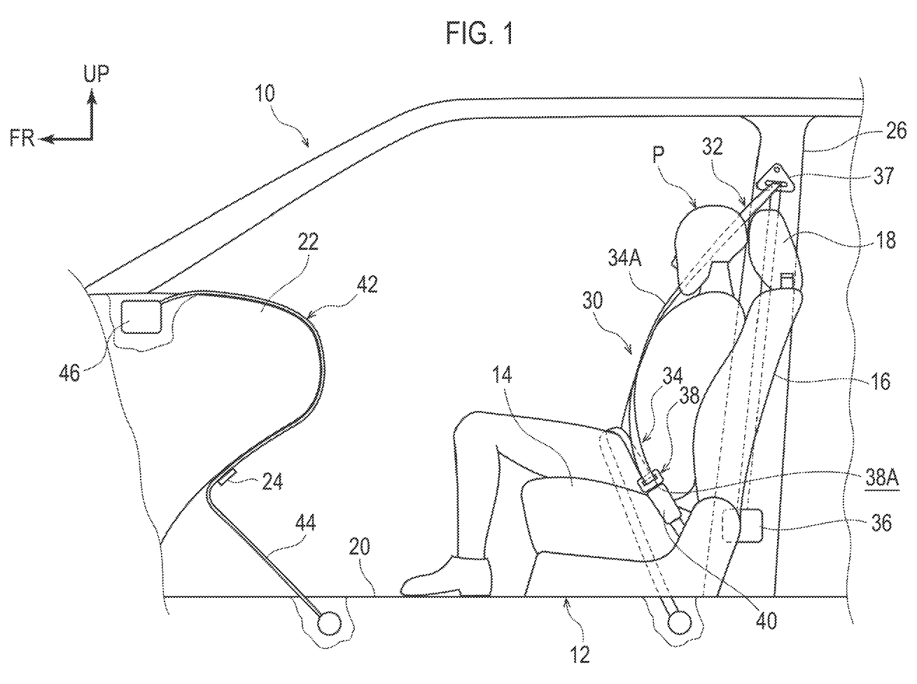

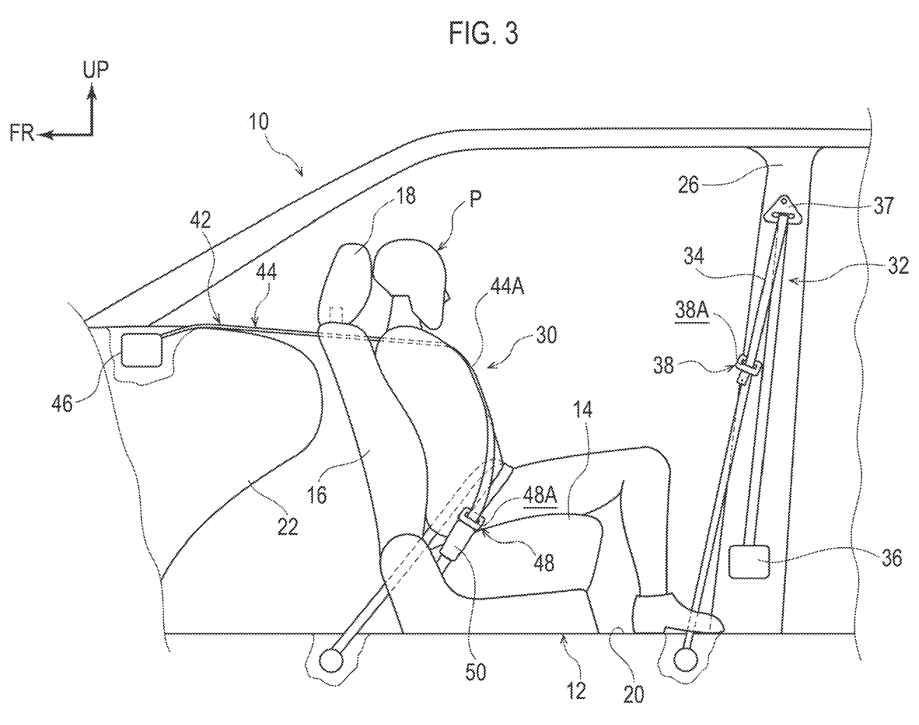

First, a first embodiment will be described. As shown in FIGS. 1 to 4, a rotating seat 12 that is changeable between a forward-facing posture and a rearward-facing posture is provided in a front seat (first row seat) of a vehicle 10 according to the first embodiment. In FIGS. 1 to 4, the rotating seat 12 of a right front seat of the vehicle 10 is shown. A case of the rotating seat of a left front seat of the vehicle 10 is otherwise identical in configuration, being mirror-symmetrical about the vehicle centerline.

The rotating seat 12 includes a seat cushion 14 that includes a rotating plate (not shown) provided on a lower side, and a seatback 16 that is provided at a rear end part of the seat cushion 14 to be rotationally movable (tiltable rearward and forward) with a seat width direction as an axial direction. The rotating seat 12 further includes a headrest 18 that is provided at a center portion of an upper end part of the seatback 16 to be movable up and down in the seat width direction.

In each drawing, a state where a dummy (human body dummy) for a collision test is sitting on the seat cushion 14 of the rotating seat 12 is shown as a model of an occupant (sitter) to be protected. The dummy is, for example, AM50 (50 percentile of an adult male in the US) of a dummy for a side collision test. The dummy is hereinafter referred to as an "occupant P".

The vehicle 10 includes a vehicle occupant restraint device 30 according to the first embodiment. The vehicle occupant restraint device 30 according to the first embodiment is configured to include at least the rotating seat 12, a pair of left and right first buckle 40 and second buckle 50, a first seat belt device 32, and a second seat belt device 42.

Specifically, the pair of left and right first buckle 40 and second buckle 50 are provided on both the left and right sides and a rear portion side of the seat cushion 14 of the rotating seat 12. In a case where the rotating seat 12 is in the forward-facing posture, the buckle located on the inner side in the vehicle-width direction is the first buckle 40, and in a case where the rotating seat 12 is in the rearward-facing posture, the buckle located on the inner side in the vehicle-width direction is the second buckle 50.

The first seat belt device 32 that includes a first tongue 38 described below that is attachable to and detachable from the first buckle 40 located on the inner side in the vehicle-width direction in a case where the rotating seat 12 is in the forward-facing posture, is provided on a B pillar (center pillar) 26 side. The first seat belt device 32 includes a first seat belt 34 and a retractor 36 that includes a winding shaft (not shown) to which a first end part of the first seat belt 34 is attached and that winds and accommodates a first end part side in a state where the first end part side is biased in a winding direction.

In addition, the first seat belt device 32 includes a shoulder anchor 37 in which a second end part side of the first seat belt 34 pulled out from the retractor 36 is disposed and supported. The first seat belt device 32 further includes the first tongue 38 that is movable with respect to the first seat belt 34 by disposing the first seat belt 34 disposed in the shoulder anchor 37 into a disposition hole 38A.

A second end part of the first seat belt 34 is fixed to a floor 20. In addition, the shoulder anchor 37 is provided at an upper portion of the B pillar 26, and the retractor 36 is built in a lower end part of the B pillar 26. In addition, hereinafter, a portion of the first seat belt 34 that is stretched over the chest of the occupant P is referred to as a shoulder belt 34A.

The second seat belt device 42 that includes a second tongue 48 described below that is attachable to and detachable from the second buckle 50 located on the inner side in the vehicle-width direction in a case where the rotating seat 12 is in the rearward-facing posture, is provided on an instrument panel 22 side. The second seat belt device 42 includes a second seat belt 44 and a retractor 46 that includes a winding shaft (not shown) to which a first end part of the second seat belt 44 is attached and that winds and accommodates a first end part side in a state where the first end part side is biased in a winding direction.

In addition, the second seat belt device 42 includes a shoulder anchor 47 on which a second end part side of the second seat belt 44 pulled out from the retractor 46 is hooked and guided. The second seat belt device 42 further includes the second tongue 48 that is movable with respect to the second seat belt 44 by disposing the second seat belt 44 in a disposition hole 48A.

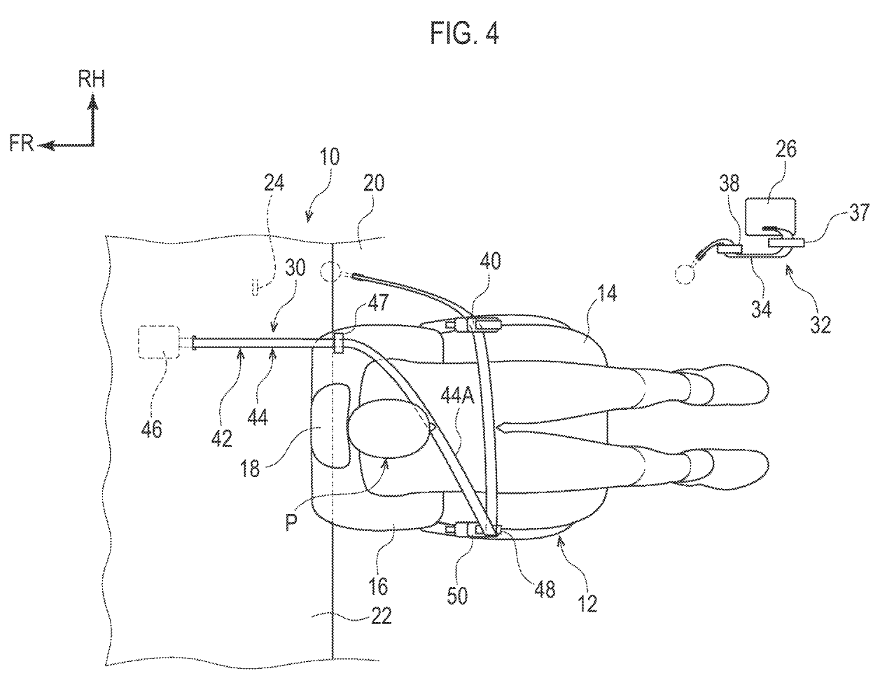

A second end part of the second seat belt 44 is fixed to the floor 20. In addition, the shoulder anchor 47 is provided on one side in the left-right direction of an upper end part of the seatback 16 that is located on an outer side in the vehicle-width direction in a case where the rotating seat 12 is in the rearward-facing posture (see FIG. 4). In addition, the retractor 46 is provided on a lower surface side of an upper front portion of the instrument panel 22.

In addition, a locking hook 24 for hooking the second end part side of the second seat belt 44 pulled out from the retractor 46 not to interfere and not to impair the appearance is provided at a lower front portion of the instrument panel 22 in a case where the rotating seat 12 is in the forward-facing posture. In addition, hereinafter, a portion of the second seat belt 44 that is stretched over the chest of the occupant P is referred to as a shoulder belt 44A.

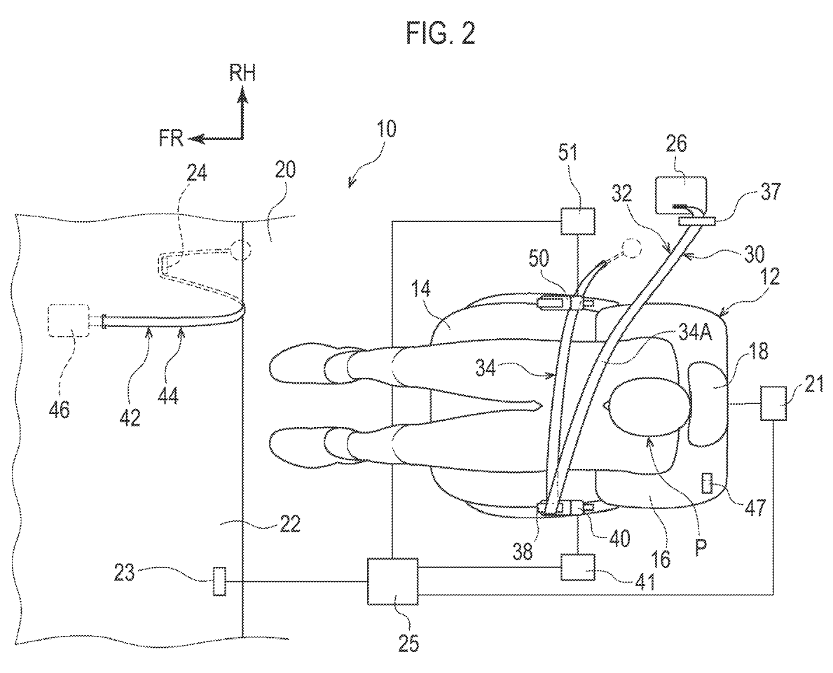

As shown in FIG. 2, a discrimination device 21 that discriminates an orientation of the rotating seat 12 is provided on the rotating seat 12 (for example, the rotating plate). The discrimination device 21 may be provided on the floor 20 instead of the rotating seat 12. An attachment and detachment detection device 41 and an attachment and detachment detection device 51 that detect that the first tongue 38 or the second tongue 48 is mounted are provided on the first buckle 40 and the second buckle 50, respectively.

In addition, the vehicle 10 is provided with a warning sound generation device 23 that generates a warning sound for the occupant P, and a control device 25 that is electrically connected to the discrimination device 21, the attachment and detachment detection devices 41, 51, and the warning sound generation device 23. The control device 25 is configured to control the warning sound generation device 23 to generate the warning sound in a next case. The next case is a case where it is determined that the detection results of the attachment and detachment detection devices 41, 51 are incompatible with the orientation of the rotating seat 12 discriminated by the discrimination device 21 and a vehicle speed is equal to or higher than a predetermined speed.

In the vehicle occupant restraint device 30 and the vehicle 10 according to the first embodiment having the above-described configuration, an operation thereof will be described below.

As described above, the rotating seat 12 that is changeable between the forward-facing posture and the rearward-facing posture is provided as the right front seat of the vehicle 10, and the first buckle 40 and the second buckle 50 are provided on both the left and right sides of the rotating seat 12, respectively. The first seat belt device 32 that includes the first tongue 38 attachable to and detachable from the first buckle 40 located on the inner side in the vehicle-width direction in a case where the rotating seat 12 is in the forward-facing posture is provided on the B pillar 26 side. The second seat belt device 42 that includes the second tongue 48 attachable to and detachable from the second buckle 50 located on the inner side in the vehicle-width direction in a case where the rotating seat 12 is in the rearward-facing posture is provided on the instrument panel 22 side.

Therefore, in a case where the rotating seat 12 is in the forward-facing posture, a load of the shoulder belt 34A in the first seat belt 34 is received by the B pillar 26. In a case where the rotating seat 12 is in the rearward-facing posture, a load of the shoulder belt 44A in the second seat belt 44 is received by the instrument panel 22. Accordingly, the rigidity of the rotating seat 12 need not be increased, thereby inhibiting an increase in mass of the rotating seat 12.

In addition, the buckle to be used is always the first buckle 40 or the second buckle 50 located on the inner side in the vehicle-width direction. Therefore, at the time of a side collision of the vehicle 10 in a state where the rotating seat 12 is in the forward-facing posture, the first tongue 38 can be easily released from the first buckle 40. In addition, at the time of a side collision of the vehicle 10 in a state where the rotating seat 12 is in the rearward-facing posture, the second tongue 48 can be easily released from the second buckle 50.

In addition, the discrimination device 21 that discriminates the orientation of the rotating seat 12 is provided on the rotating seat 12 or the floor 20. In addition, the attachment and detachment detection device 41 and the attachment and detachment detection device 51 that detect that the first tongue 38 or the second tongue 48 is mounted are provided on the first buckle 40 and the second buckle 50, respectively. The vehicle 10 includes the warning sound generation device 23 that generates a warning sound for the occupant P, and the control device 25 that is electrically connected to the discrimination device 21, the attachment and detachment detection devices 41, 51, and the warning sound generation device 23.

Here, in a case where the detection results of the attachment and detachment detection devices 41, 51 are the next case, the control device 25 controls the warning sound generation device 23 to generate the warning sound. The next case is a case where the control device 25 makes a determination that the detection results of the attachment and detachment detection devices 41, 51 are incompatible with the orientation of the rotating seat 12 discriminated by the discrimination device 21 and a vehicle speed is equal to or higher than a predetermined speed. Therefore, it is possible to prompt the occupant P who is sitting on the rotating seat 12 to correctly wear the first seat belt 34 or the second seat belt 44.

### Second Embodiment

Next, a second embodiment will be described. The same reference numerals are assigned to the same portions as those in the first embodiment, and detailed description thereof will be omitted as appropriate.

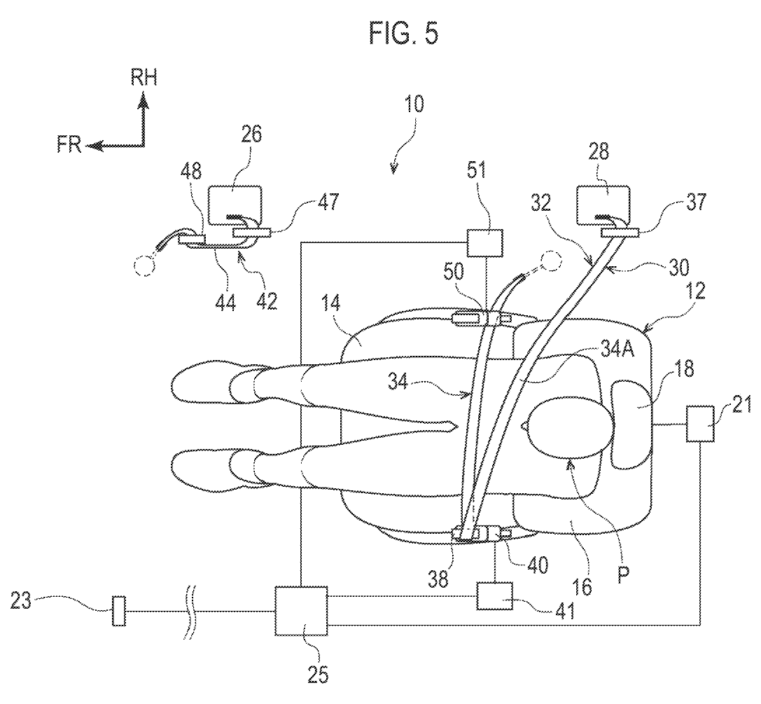

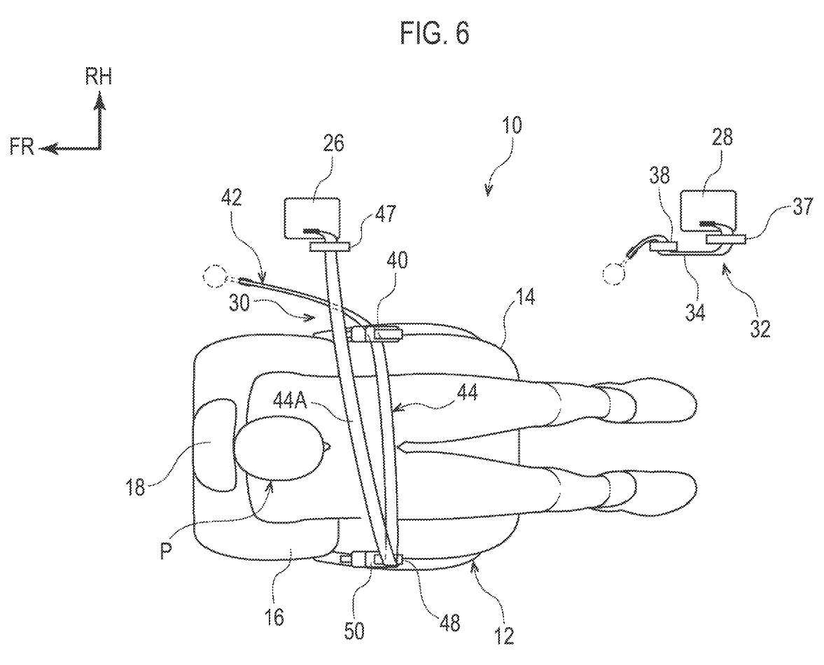

As shown in FIGS. 5 and 6, the rotating seat 12 that is changeable between the forward-facing posture and the rearward-facing posture is provided in a rear seat (second row seat) of the vehicle 10 according to the second embodiment. In FIGS. 5 and 6, the rotating seat 12 of a right rear seat of the vehicle 10 is shown. A case of the rotating seat of a left rear seat of the vehicle 10 is otherwise identical in configuration, being mirror-symmetrical about the vehicle centerline.

The vehicle occupant restraint device 30 according to the second embodiment is configured to include at least the rotating seat 12, the pair of left and right first buckle 40 and second buckle 50, the first seat belt device 32, and the second seat belt device 42, as in the first embodiment.

The first seat belt device 32 that includes the first tongue 38 attachable to and detachable from the first buckle 40 located on the inner side in the vehicle-width direction in a case where the rotating seat 12 is in the forward-facing posture is provided on a C pillar (rear pillar) 28 side. That is, the first seat belt device 32 includes the first seat belt 34, a retractor (not shown), the shoulder anchor 37, and the first tongue 38. A second end part of the first seat belt 34 is fixed to a floor 20. In addition, the shoulder anchor 37 is provided at an upper portion of the C pillar 28, and the retractor is built in a lower end part of the C pillar 28.

In addition, the second seat belt device 42 that includes the second tongue 48 attachable to and detachable from the second buckle 50 located on the inner side in the vehicle-width direction in a case where the rotating seat 12 is in the rearward-facing posture is provided on the B pillar 26 side. That is, the second seat belt device 42 includes the second seat belt 44, a retractor (not shown), and a shoulder anchor 47 equivalent to the shoulder anchor 37, and the second tongue 48. A second end part of the second seat belt 44 is fixed to the floor 20. In addition, the shoulder anchor 47 is provided at an upper portion of the B pillar 26, and the retractor is built in a lower end part of the B pillar 26.

In the vehicle occupant restraint device 30 and the vehicle 10 according to the second embodiment having the above-described configuration, an operation thereof will be described below. Detailed description of the same operation as that in the first embodiment will be omitted as appropriate.

As described above, the rotating seat 12 that is changeable between the forward-facing posture and the rearward-facing posture is provided as the right rear seat of the vehicle 10, and the first buckle 40 and the second buckle 50 are provided on both the left and right sides of the rotating seat 12, respectively. The first seat belt device 32 that includes the first tongue 38 attachable to and detachable from the first buckle 40 located on the inner side in the vehicle-width direction in a case where the rotating seat 12 is in the forward-facing posture is provided on the C pillar 28 side. The second seat belt device 42 that includes the second tongue 48 attachable to and detachable from the second buckle 50 located on the inner side in the vehicle-width direction in a case where the rotating seat 12 is in the rearward-facing posture is provided on the B pillar 26 side.

Therefore, in a case where the rotating seat 12 is in the forward-facing posture, a load of the shoulder belt 34A in the first seat belt 34 is received by the C pillar 28. In a case where the rotating seat 12 is in the rearward-facing posture, a load of the shoulder belt 44A in the second seat belt 44 is received by the B pillar 26. Accordingly, the rigidity of the rotating seat 12 need not be increased, thereby inhibiting an increase in mass of the rotating seat 12.

In addition, the buckle to be used is always the first buckle 40 or the second buckle 50 located on the inner side in the vehicle-width direction. Therefore, at the time of a side collision of the vehicle 10 in a state where the rotating seat 12 is in the forward-facing posture, the first tongue 38 can be easily released from the first buckle 40. At the time of a side collision of the vehicle 10 in a state where the rotating seat 12 is in the rearward-facing posture, the second tongue 48 can be easily released from the second buckle 50.

In addition, as in the first embodiment, the discrimination device 21 that discriminates the orientation of the rotating seat 12 is provided on the rotating seat 12 or the floor 20. The attachment and detachment detection device 41 and the attachment and detachment detection device 51 that detect that the first tongue 38 or the second tongue 48 is mounted are provided on the first buckle 40 and the second buckle 50, respectively (see FIG. 5).

Therefore, in a case where the detection results of the attachment and detachment detection devices 41, 51 are the next case, the control device 25 controls the warning sound generation device 23 to generate the warning sound. The next case is a case where the control device 25 makes a determination that the detection results of the attachment and detachment detection devices 41, 51 are incompatible with the orientation of the rotating seat 12 discriminated by the discrimination device 21 and a vehicle speed is equal to or higher than a predetermined speed. As a result, it is possible to prompt the occupant P who is sitting on the rotating seat 12 to correctly wear the first seat belt 34 or the second seat belt 44.

The vehicle occupant restraint device 30 and the vehicle 10 according to the present embodiment have been described above with reference to the drawings. However, the vehicle occupant restraint device 30 and the vehicle 10 according to the present embodiment are not limited to the illustrated configurations and can be appropriately redesigned without departing from the gist of the present disclosure.

For example, the discrimination device 21 is not limited to the configuration in which the discrimination device 21 is provided on the rotating plate provided on the lower side of the seat cushion 14 or the floor 20, and may be configured with a camera (not shown) provided in the vehicle cabin. In addition, in the second embodiment, the first seat belt device 32 and the like may be provided on a ceiling of the vehicle cabin or the like instead of the C pillar 28.

What is claimed is:

1. A vehicle occupant restraint device comprising:
a rotating seat provided as a front seat of a vehicle and changeable between a forward-facing posture and a rearward-facing posture;
a first buckle and a second buckle that are provided on both left and right sides of the rotating seat, respectively;
a first seat belt device provided on a B pillar side and including a first tongue attachable to and detachable from the first buckle that is located on an inner side in a vehicle-width direction when the rotating seat is in the forward-facing posture; and
a second seat belt device provided on an instrument panel side and including a second tongue attachable to and detachable from the second buckle that is located on the inner side in the vehicle-width direction when the rotating seat is in the rearward-facing posture.

2. A vehicle comprising:
the vehicle occupant restraint device according to claim 1;
a discrimination device provided on the rotating seat or a floor and configured to discriminate an orientation of the rotating seat;
an attachment and detachment detection device provided on each of the first buckle and the second buckle and configured to detect that the first tongue or the second tongue is attached;
a warning sound generation device configured to generate a warning sound for an occupant; and
a control device electrically connected to the discrimination device, the attachment and detachment detection device, and the warning sound generation device, wherein the control device is configured to control the warning sound generation device to generate the warning sound when a determination is made that a detection result of the attachment and detachment detection device is incompatible with the orientation of the rotating seat discriminated by the discrimination device and a vehicle speed is equal to or higher than a predetermined speed.

3. A vehicle occupant restraint device comprising:
a rotating seat provided as a rear seat of a vehicle and changeable between a forward-facing posture and a rearward-facing posture;
a first buckle and a second buckle that are provided on both left and right sides of the rotating seat, respectively;
a first seat belt device provided on a C pillar side and including a first tongue attachable to and detachable from the first buckle that is located on an inner side in a vehicle-width direction when the rotating seat is in the forward-facing posture; and
a second seat belt device provided on a B pillar side and including a second tongue attachable to and detachable from the second buckle that is located on the inner side in the vehicle-width direction when the rotating seat is in the rearward-facing posture.

4. A vehicle comprising:
the vehicle occupant restraint device according to claim 3;
a discrimination device provided on the rotating seat or a floor and configured to discriminate an orientation of the rotating seat;
an attachment and detachment detection device provided on each of the first buckle and the second buckle and configured to detect that the first tongue or the second tongue is attached;
a warning sound generation device configured to generate a warning sound for an occupant; and
a control device electrically connected to the discrimination device, the attachment and detachment detection device, and the warning sound generation device, wherein the control device is configured to control the warning sound generation device to generate the warning sound when a determination is made that a detection result of the attachment and detachment detection device is incompatible with the orientation of the rotating seat discriminated by the discrimination device and a vehicle speed is equal to or higher than a predetermined speed.
